(19) United States
(12) Patent Application Publication
(10) Pub. No.: US 2013/0045015 A1
(43) Pub. Date: Feb. 21, 2013

(54) METHOD AND ARRANGEMENT FOR SIGNAL PROCESSING IN A COMMUNICATION SYSTEM

(71) Applicants: Maxim Kuschnerov, Muenchen (DE); Bernhard Spinnler, Oberhaching (DE); Berthold Lankl, Egmating (DE); Antonio Napoli, Muenchen (DE); Stefano Calabro, Muenchen (DE)

(72) Inventors: Maxim Kuschnerov, Muenchen (DE); Bernhard Spinnler, Oberhaching (DE); Berthold Lankl, Egmating (DE); Antonio Napoli, Muenchen (DE); Stefano Calabro, Muenchen (DE)

(73) Assignee: NOKIA SIEMENS NETWORKS GMBH & CO. KG, MUENCHEN (DE)

(21) Appl. No.: 13/695,095

(22) PCT Filed: Apr. 27, 2011
(86) PCT No.: PCT/EP11/56619

§ 371 Date: Oct. 29, 2012

(30) Foreign Application Priority Data
Apr. 29, 2010 (EP) 101 61 450

(51) Int. Cl. H04B 10/06

(52) U.S. Cl. 398/208; 398/202

(57) ABSTRACT

A signal processing method and a signal processing arrangement for coherent receivers are provided. The method includes the steps of receiving a coherent complex signal, extracting orthogonal in-phase and quadrature signal components from the coherent complex signal, quantizing the orthogonal signal components independently, combining the quantized orthogonal signal components as real and imaginary part of a complex number resulting in a first signal, and soft differential decoding the first signal resulting in a second signal.

### FIELD OF THE INVENTION

The invention refers to a method and to an arrangement for signal processing in a communication system (e.g. an optical communication system).

### BACKGROUND OF THE INVENTION

In order to meet the growing demand for internet bandwidth with traffic growth rates around 40-50% per year, telecommunication component providers face the task of increasing the spectral efficiency of fiber utilization. After 10 Gbit/s systems became successful in the 1990's, solutions for 40 Gbit/s became available in the last years. Standardization and research are now focused on the development of 100 Gbit/s systems with coherent Polarization Multiplexed (PolMux) Quadrature Phase Shift Keying (QPSK). Since polarization multiplexing utilizes both light polarizations, it is possible to send the signal at a rate of ˜25-28 Gsymbols per second, thus fitting nicely into the standard 50 GHz grid for DWDM optical systems. Coherent reception makes it possible to compensate for most linear transmission impairments, like Chromatic Dispersion (CD) and Polarization-Mode Dispersion (PMD) after sampling in the digital domain.

FIG. 1 shows a conventional coherent receiver for polarization multiplex signals. A received polarization division multiplex signal (PolMUX signal) 14 comprising two orthogonal optical signals is split by a Polarisation Beam Splitter (PBS) 1 into two orthogonal component signals x and y. Each of these component signals is split by optical 90°-hybrids 2 and 3 into an in-phase component (xi; yi) and a quadrature-phase component (xq; yq). Therefore frequency and phase of a local carrier generated by a local oscillator (LO) 4 must be adjusted by a carrier recovery unit 12 to agree with that of the received PolMUX signal. After analogue-to-digital conversion by AD-converters (ADC) 5-8 a sampled and quantized representation of the received optical signal is available in digital form referred to as component values XI, XQ; YI, YQ. Such values contain statistic noisy distortions, deterministic channel degradations such as chromatic dispersion, and random time-varying distortions mainly due to polarization effects. A dispersion compensation unit 9 is usually added for first coarse chromatic dispersion compensation. In addition, a clock recovery subsystem 10 is necessary for extracting a correct sampling clock frequency and a correct sampling clock phase from the received signal. Adaptive equalization estimates the channel and removes deterministic channel distortions. Then, the carrier recovery 12 corrects the phase offset caused by the local oscillator (LO) 4. Finally, forward error correction (FEC) 13 is used to correct for statistical errors.

FIG. 2 shows the rotation of a Quadrature Phase Shift Keying (QPSK) constellation diagram relative to either polarization component x or y in presence of a phase offset Δφ(t) introduced by the transmitter and receiver laser to the signal. Writing the analog signal Eᵢₙ(t) in the complex base-band, a phase offset Δφ(t) can be modeled by Eₒᵤₜ(t)=Eᵢₙ(t)e^{jΛφ}. In more detail FIG. 2 shows the Quadrature Phase Shift Keying (QPSK) constellation diagram 21 without the phase rotation and the Quadrature Phase Shift Keying (QPSK) constellation 22 in presence of the phase offset Δφ(t) 23.

FIG. 3 shows an example of a cycle slip for a Quadrature Phase Shift Keying (QPSK) system in presence of a constant phase offset Δφ(t). In more detail FIG. 3 shows the phase 31 (rad) as a function of the number of received symbols 32 and an example of a cycle slip 33. A cycle slip occurs if the signal constellation is rotated by ±90°, 180°. Depending on the signal-to-noise ratio (SNR) and the laser phase noise, there is a finite probability that cycle slips occur. All the subsequent phase estimates are offset by the degree of the cycle slip and decoded incorrectly in a coherent system. This can lead to burst errors thus making a stable communication impossible. The probability of cycle slips can be reduced by using lasers with a narrower linewidth or by increasing the SNR, which may lead to more expensive communication systems.

A much simpler way to combat cycle slips can be obtained by introducing differential encoding to the signal. In conventional differential formats, the bit information is modulated onto the phase difference between two or more subsequent symbols. For example, in differentially encoded Binary Phase-Shift Keying (BPSK) systems a binary “1” may be transmitted by adding 180° to the current phase and a binary “0” by adding 0° to the current phase. In differentially encoded QPSK, the phase-shifts are 0°, 90°, 180°, −90° corresponding to data “00”, “01”, “11”, “10”. If a cycle slip occurs, it leads to a single symbol error only, since it's the differential phase which carries the information.

However, binary differential decoding may lead to a performance loss, as every bit error in the coherent domain is translated to two bit errors after differential decoding at relevant signal-to-noise ratio (SNR) values. The binary decoding algorithm can be given by:

z_{I}(t)=Re {sgn(r(t))sgn(r*(t−T))}; z_{Q}(t)=Im {sgn(r(t))sgn(r*(t−T))} (1)

where r(t) is the coherent complex signal and z(t) is the complex differentially decoded signal with z_{I}(t) being the real part or the in-phase, z_{Q}(t) being the imaginary part or the quadrature, and T is the symbol duration.

FIG. 4 illustrates the bit error rate (BER) of a Quadrature Phase Shift Keying (QPSK) 43 compared with a binary differentially decoded QPSK 44 and with a standard soft decoding (incoherent demodulation) of QPSK 45 (DQPSK). In more detail FIG. 4 shows that the loss by binary differentially decoded QPSK 44 with respect to Phase Shift Keying (QPSK) is about ˜0.7 dB at a BER of 5e-3. The loss itself is not as relevant in the first place as the implication of differential decoding itself. As shown in FIG. 1, in the coherent receiver, the carrier recovery stage 12 is followed by the Forward error Correction (FEC) stage 13. Generally, coding benefits from soft information, whenever a quantized version of the output signal is used for decoding instead of hard-decision bits. In this way, the decoding algorithm can utilize information of the symbol uncertainty in order to improve decoding performance. At coding overheads of ˜7% that are common in optical communication, the soft decoding channel capacity is ˜1 dB higher than the hard decision channel capacity. However, there is the problem of transferring soft-information of differentially encoded QPSK from the coherent to the differentially decoded domain. FIG. 4 shows that the standard soft decoding of QPSK (DQPSK) 45 leads to a significant penalty compared with binary differentially decoded QPSK 44 of ˜1.7 dB at a BER of 5e-3.

The output signal of the DQPSK decoder is given by:

z_{I}(t)=Re {r(t)r*(t−T)}; z_{Q}(t)=Im {r(t)r*(t−T)} (2)

Binary differential decoding of QPSK has a limited decoding penalty, less than soft differential decoding, but suffers a performance loss in combination with hard-decision FEC that is inferior to soft-decision counterparts. Another possibility would be to avoid differential encoding altogether. However this approach would require stable lasers and generally leads to increased system costs.

In the wireless systems literature it has been shown that the differential encoding penalty of general PSK modulation formats can be completely compensated using iterative decoding. Cited for example are D. Marsland, P. T. Mathiopoulos, “On the Performance of Iterative Noncoherent Detection of Coded M-PSK Signals”, IEEE Transactions on Communications, vol. 48, no. 4, pp. 588-596, April 2000; Peter Hoeher, Senior Member, IEEE, and John Lodge, ““Turbo DPSK”: Iterative Differential PSK Demodulation and Channel Decoding”, IEEE Transactions on Communications, vol. 47, no. 6, pp. 837-843, June 1999; and H. Arslan, G. E. Bottomley, R. Ramesh, G. Brismark, “Coherent MAP Detection of DQPSK Signals in non-ISI Channels”, Wireless Communications and Networking Conference, 1999. WCNC. 1999 IEEE. In the cited documents the differential decoder is regarded as the inner code of a serially concatenated code structure. The outer code is a convolutional code with error correction capabilities. Using the turbo principle, soft information is iterated between the differential decoder and the outer code employing an interleaver in between. The soft decision is computed according to the maximum a posteriori (MAP) principle. In principle, it is possible to replace the convolutional code by a soft output low density parity check (LDPC) or turbo code with a low overhead, as they are typically used in fiber optics, in order to compensate for the differential penalty. However, this has neither been demonstrated in fiber optic literature, nor has an assessment of the complexity increase taken place. Further examples for the mitigation of the differential encoding are given in L. Lampe et al., “Coded Modulation for DPSK on Fading Channels”, Globecom 99, where multi-level coding is used in combination with convolutional codes, and in H. Leib et al., “Data-Aided Noncoherent Demodulation of DPSK”, IEEE Trans. Comm. Vol. 43 (1995), pp. 722 and S. Calabrò et al., “Improved Detection of differential Phase Shift Keying through Multi-Symbol Phase Estimation”, ECOC 2005, where recursive structures are employed that however cannot be implemented in parallelized receivers.

The problem to be solved is to avoid the disadvantage mentioned above and in particular to reduce the performance loss of the soft differential decoding of QPSK in the combination with Forward error Correction (FEC). A cost efficient technique is needed that approaches the optimal performance of soft differential decoding of QPSK in the combination with Forward error Correction (FEC) without the complexity of MAP computation and iterative decoding, and which can be easily implemented in parallelized receivers.

### SUMMARY OF THE INVENTION

In order to overcome the above-described need in the art, the present invention discloses a signal processing method for coherent receivers, comprising the steps of receiving a coherent complex signal, extracting orthogonal in-phase and quadrature signal components from the coherent complex signal, quantizing the orthogonal signal components independently, combining the quantized orthogonal signal components obtaining a first signal (in particular, a complex signal), and soft differential decoding the first signal obtaining a second signal.

It is also an embodiment, that the first signal (61) includes a real part (693) and an imaginary part.

In a further embodiment, the signal processing method further comprises the step of feeding the second signal to a forward error correction unit.

In other embodiments of the present invention, the coherent complex signal is fed by a carrier recovery unit.

In a further embodiment, the step of soft differential decoding the first signal obtaining a second signal includes the steps of time-delaying the first signal obtaining a third signal, complex conjugating the third signal obtaining a fourth signal, multiplying the fourth signal with the first signal obtaining a fifth signal, and phase shifting the fifth signal obtaining the second signal.

In a next embodiment, the coherent complex signal includes a Quadrature Phase Shift Keying (QPSK) signal.

It is also an embodiment, that the signal processing method further comprises the step of clipping the orthogonal signal components independently.

In a further embodiment, the step of quantizing the orthogonal signal components independently includes linear quantization of the orthogonal signal components.

In an alternative embodiment, the step of quantizing the orthogonal signal components independently includes non linear quantization of the signal components.

In other embodiments of the present invention, the non linear quantization of the orthogonal signal components includes compression of the orthogonal signal components.

In a next embodiment of the invention, the non linear quantization of the orthogonal signal components includes expansion of the orthogonal signal components.

The problem stated above is also solved by a signal processing arrangement for coherent receivers, comprising means for receiving a coherent complex signal, means for extracting orthogonal in-phase and quadrature signal components from the coherent complex signal, means for quantizing the orthogonal signal components independently, means for combining the quantized orthogonal signal components obtaining a first signal, wherein the first signal includes a real part and an imaginary part, and means for soft differential decoding the first signal obtaining a second signal.

In a next embodiment, the means for quantizing the orthogonal signal components independently include a quantization and clipping unit.

In other embodiments of the present invention, the means for quantizing the orthogonal signal components independently include a compressor unit configured to perform compression of the orthogonal signal components.

In a next embodiment, the means for quantizing the orthogonal signal components independently include an expander unit configured to perform expansion of the orthogonal signal components.

The problem stated above is also solved by a receiver of a communication system including the signal processing arrangement described above.

### BRIEF DESCRIPTION OF THE DRAWINGS

The invention is explained by way of example in more detail below with the aid of the attached drawings.

FIG. 1 a high level block diagram which shows a conventional coherent receiver for polarization multiplex signals.

FIG. 2 is an illustration which shows the rotation of a Quadrature Phase Shift Keying (QPSK) constellation diagram in presence of a phase offset.

FIG. 3 is an illustration which shows a cycle slip for a Quadrature Phase Shift Keying (QPSK) system.

FIG. 4 illustrates the bit error rate (BER) of a Quadrature Phase Shift Keying (QPSK) compared with a binary differentially decoded QPSK and with a standard soft decoding of QPSK (DQPSK).

FIG. 5 is a high level block diagram which illustrates the signal processing arrangement and the method of processing a coherent complex signal according to an embodiment of the invention.

FIG. 6 is high level block diagram which illustrates the soft decision code I.5 from the fiber optic communication standard ITU-T G.975.1.

FIG. 7 illustrates the performance of the soft differential decoding method in combination with a soft decision forward error correction (FEC) according to an embodiment of the invention.

### DESCRIPTION OF THE INVENTION

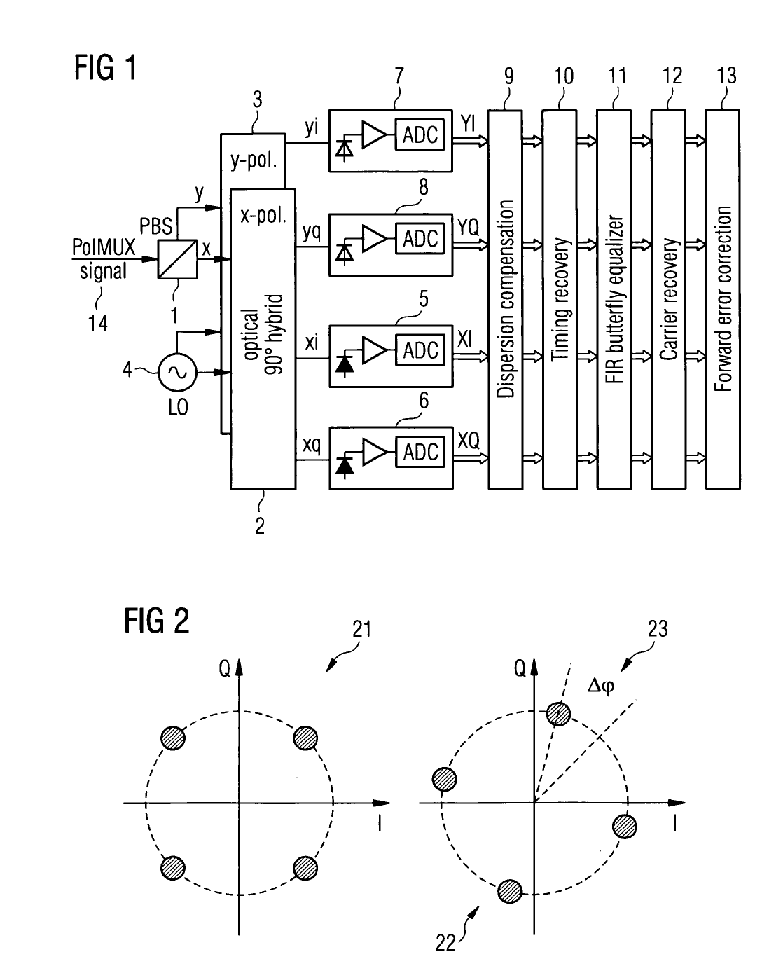

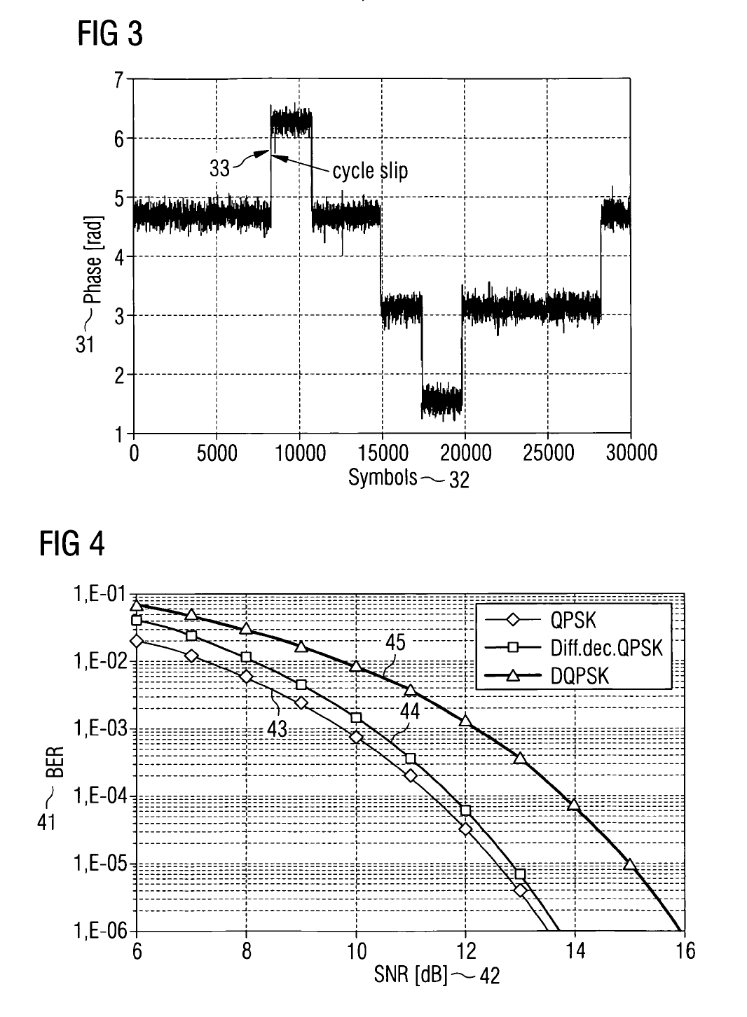

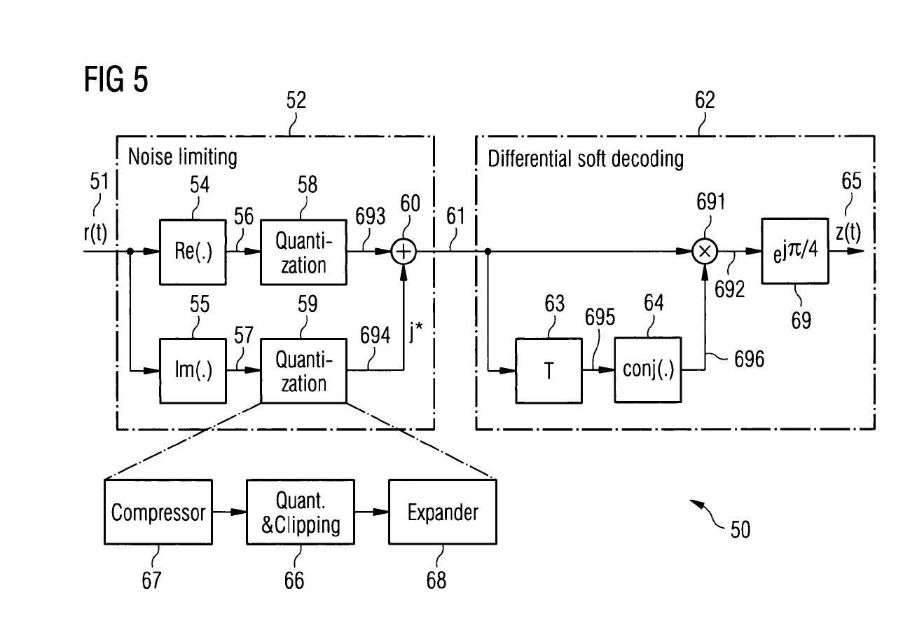

As regards the description of FIGS. 1 to 4, reference is made to the background of the invention.

Illustrative embodiments will now be described with reference to the accompanying drawings to disclose the teachings of the present invention. While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

FIG. 5 is high level block diagram (50) which illustrates the signal processing arrangement and the method of processing a coherently demodulated complex signal r(t) according to an embodiment of the invention. The coherently demodulated complex signal r(t) is fed from a carrier recovery unit (for example the carrier recovery unit 12 shown in FIG. 1) to a noise limiting unit 52. The in-phase component 56 of the coherent complex signal r(t) is extracted by the in-phase component extractor unit 54 and quantized by the quantization unit 58. Independently from the in-phase component, the quadrature component 57 of the coherent complex signal r(t) is extracted by the quadrature component extractor 55 and quantized by the quantization unit 59. The in-phase component 56 and the quadrature component 57 of the coherently demodulated complex signal r(t) are combined (60) as real (693) and imaginary (694) part of a complex number, respectively, by the combiner 60. The resulting signal 61 is then fed to a differential soft decoding unit 62 where differential soft decoding of the signal 61 is performed. In particular the signal 61 is fed to a time delay unit 63 which introduces a time delay T. The output 695 of the time delay unit 63 is then fed to a complex conjugate unit 64. The output 696 of the complex conjugate unit 64 is then multiplied with the signal 61 by the multiplier 691. The resulting signal 692 is fed to a π/4 phase shifter 69. The output of the phase shifter z(t) 65 can then be processed by an error decoding module, (for example the forward error correction (FEC) unit 13 shown in FIG. 1).

In another embodiment of the invention, also shown in FIG. 5, the quantization units 58 and 59 further include a clipping unit, so that each of the quantization unit 58 and 59 can also be named quantization and clipping unit 66. The clipping in combination with quantization leads to a significant noise reduction compared to standard soft differential decoding.

According to an embodiment of the invention the quantization units 58 and 59 perform a linear quantization.

In another embodiment of the invention, also shown in FIG. 5, the quantization performed by quantization units 58 and 59 can be non linear. In particular nonlinear mapping functions units can be included before and after the linear quantization and clipping units 66, in particular a compressor unit 67 is included before the quantization and clipping units 66 and an expander unit 68 is included after the quantization and clipping units 66. Further benefits can be gained by using the nonlinear mapping functions units 67 and 68. The optimum clipping amplitude and nonlinear mapping functions depend on the type of forward error correction (FEC).

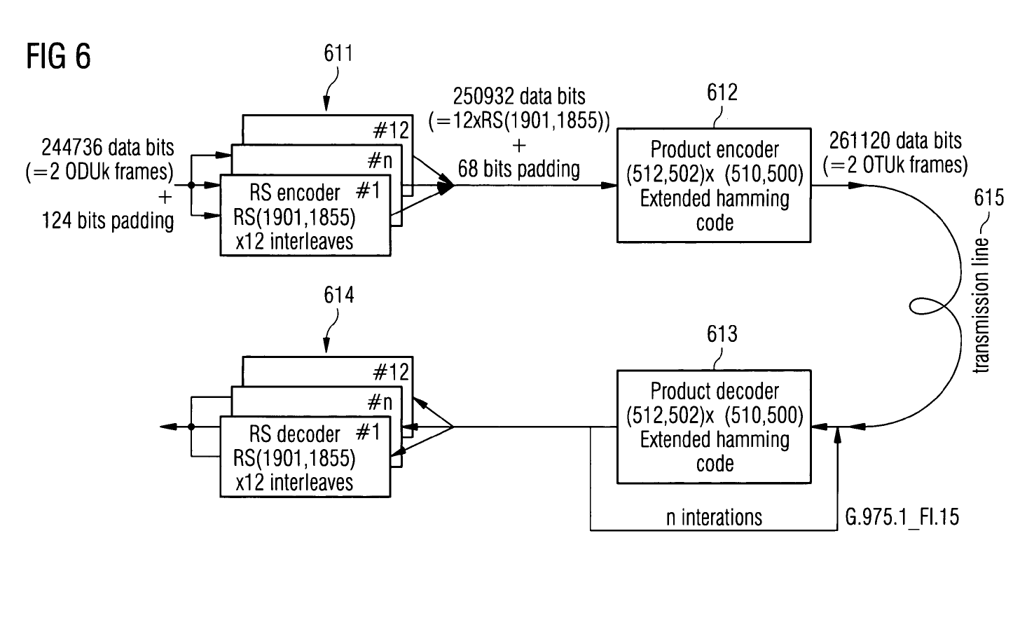

FIG. 6 is high level block diagram which illustrates the soft decision code I.5 from the fiber optic communication standard ITU-T G.975.1. In particular FIG. 6 shows a Reed-Solomon encoder unit 611, a Product encoder unit 612, a transmission line 615, a Product decoder unit 613 and a Reed-Solomon decoder unit 614. The performance of the soft differential decoding of DQPSK according to an embodiment of the invention is demonstrated on the soft decision code I.5 from the fiber optic communication standard ITU-T G.975.1 shown in FIG. 6. The encoder uses two concatenated codes, with an outer Reed-Solomon hard-decision code and a soft-decision block-turbo product code using Hamming codes as sub-codes. The soft-decision code utilizes 2-3 soft bits. The decoding involves several iterations that are typical for turbo codes. The outer Reed-Solomon code then corrects the residual errors. The soft-decoding of the inner code is performed using the Chase algorithm as described in R. M. Pyndiah, “Near-Optimum Decoding of Product Codes: Block Turbo Codes”, IEEE Transactions on Communications, vol. 46, no. 8, pp. 1003-1010, August 1997.

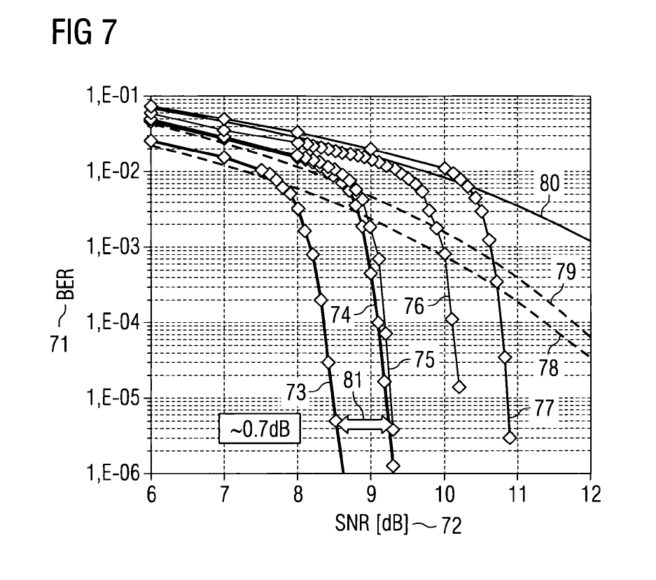

FIG. 7 illustrates the performance of the soft differential decoding method in combination with a soft decision forward error correction (FEC) according to an embodiment of the invention. In more detail, FIG. 7 shows the bit error rate (BER) of a coherent Quadrature Phase Shift Keying (QPSK) 78 before being processed by a forward error correction (FEC) unit; the BER of a binary differentially decoded QPSK 79 before being processed by a forward error correction (FEC) unit; the BER of a standard soft decoding of QPSK (DQPSK) 80 before being processed by a forward error correction (FEC) unit; the BER of a coherent Phase Shift Keying (QPSK) 73 after being processed by a forward error correction (FEC) unit; the BER of a soft differential decoded QPSK (DQPSK) 74, according to an embodiment of the invention, at 3 bits of non linear quantization (including compression and expansion) and a clipping level of 0.6, after being processed by a forward error correction (FEC) unit (soft-decision FEC); the BER of a soft differential decoded QPSK (DQPSK) 75, according to an embodiment of the invention, at 3 bits of linear quantization and a clipping level of 0.6, after being processed by a forward error correction (FEC) unit (soft-decision FEC); the BER of a soft differential decoded QPSK (DQPSK) 76, according to an embodiment of the invention, at 3 bits of quantization and a clipping level of 1, after being processed by a forward error correction (FEC) unit (soft-decision FEC); the BER of a soft differential decoded QPSK (DQPSK) 77, according to an embodiment of the invention, at 10 bits of quantization and a clipping level of 3, after being processed by a forward error correction (FEC) unit (soft-decision FEC)

Only the performance of the inner soft-code is evaluated, since it is sufficient to describe the overall code performance. The penalty 81 after forward error correction (FEC) decoding is ˜0.7 dB at 3 bits of quantization and is thus identical to the penalty caused by binary differential decoding. This is the minimum possible penalty that can be achieved without using iterative concatenated convolution codes as discussed before. Decoding with 2 bits quantization gives a penalty of ˜0.7 dB as well, although it is not shown in FIG. 7. Just for comparison, also the FEC performance for different clipping levels is shown. For example, if the clipping level is 0.6, then the signal is quantized between the amplitude of [−0.6; 0.6]. The original signal amplitudes without noise are assumed as [−1; 1]. The optimum choice of the clipping function ensures best performance.

FIG. 7 shows as well the performance for 10 bits of quantization and a high clipping level of 3, which corresponds to a standard soft DQPSK decoding or differential demodulation of QPSK. It is apparent that the output BER of the FEC (after forward error correction) is a function of the input BER (before forward error correction), so that the resulting performance deterioration directly depends on the worse BER before the FEC.

The described method, according to an embodiment of the invention, makes it possible to compute soft information after differential decoding, while having the minimum differential loss of binary decoding.

The described method, according to an embodiment of the invention, can be implemented on an integrated circuit in the digital domain, for example on an application-specific integrated circuit (ASIC), field-programmable gate array (FPGA) or similar technologies. The parameters of quantization in the soft differential decoding algorithm have to be optimized with respect to the given FEC algorithm. The quantization levels in the differential decoder have to be adjusted to the quantization levels of the FEC. No iterations between the differential decoding and FEC are required and they can function in a strictly feed-forward setting.

The present invention is not limited to the details of the above described principles. The scope of the invention is defined by the appended claims and all changes and modifications as fall within the equivalents of the scope of the claims are therefore to be embraced by the invention. Mathematical conversions or equivalent calculations of the signal values based on the inventive method or the use of analogue signals instead of digital values are also incorporated.

1-15. (canceled)

16. A signal processing method for coherent receivers, which comprises the steps of:
receiving a coherent complex signal;
extracting orthogonal signal components, including orthogonal in-phase and quadrature signal components, from the coherent complex signal;
quantizing the orthogonal signal components independently resulting in quantized orthogonal signal components;
combining the quantized orthogonal signal components resulting in a first signal; and
performing a soft differential decoding of the first signal resulting in a second signal.

17. The signal processing method according to claim 16, wherein the first signal has a real part and an imaginary part.

18. The signal processing method according to claim 16, which further comprises feeding the second signal to a forward error correction unit.

19. The signal processing method according to claim 16, which further comprises feeding the coherent complex signal via a carrier recovery unit.

20. The signal processing method according to claim 16, wherein the step of performing the soft differential decoding of the first signal further includes:
time-delaying the first signal resulting in a third signal;
complex conjugating the third signal into a fourth signal;
multiplying the fourth signal with the first signal resulting in a fifth signal; and
phase shifting the fifth signal resulting in the second signal.

21. The signal processing method according to claim 16, wherein the coherent complex signal includes a quadrature phase shift keying (QPSK) signal.

22. The signal processing method according to claim 16, which further comprises clipping the orthogonal signal components independently.

23. The signal processing method according to claim 16, wherein the step of quantizing the orthogonal signal components independently includes linear quantization of the orthogonal signal components.

24. The signal processing method according to claim 16, wherein the step of quantizing the orthogonal signal components independently includes non linear quantization of the signal components.

25. The signal processing method according to claim 24, which further comprises compressing the orthogonal signal components during the step of non linear quantization of the orthogonal signal components.

26. The signal processing method according to claim 24, which further comprises expanding the orthogonal signal components during the step of non linear quantization of the orthogonal signal components.

27. A signal processing configuration for coherent receivers, the signal processing configuration comprising:
means for receiving a coherent complex signal;
means for extracting orthogonal signal components, including orthogonal in-phase and quadrature signal components, from the coherent complex signal;
means for quantizing the orthogonal in-phase and quadrature signal components independently resulting in quantized orthogonal signal components;
means for combining the quantized orthogonal signal components resulting in a first signal, wherein the first signal includes a real part and an imaginary part; and
means for performing a soft differential decoding of the first signal resulting in a second signal.

28. The signal processing configuration according to claim 27, wherein said means for quantizing the orthogonal signal components independently include a quantization and clipping unit.

29. The signal processing configuration according to claim 27, wherein said means for quantizing the orthogonal signal components independently include a compressor unit configured to perform compression of the orthogonal signal components.

30. The signal processing configuration according to claim 27, wherein said means for quantizing the orthogonal signal components independently include an expander unit configured to perform expansion of the orthogonal signal components.
